(19) United States
(12) Patent Application Publication
(10) Pub. No.: US 2023/0160403 A1
(43) Pub. Date: May 25, 2023

(54) DEPLOYABLE ENERGY SUPPLY AND MANAGEMENT SYSTEM

(71) Applicant: Advanced Energy Storage, LLC, Sandusky, OH (US)

(72) Inventors: Jamie A.M. O'Brien, LaSalle, MI (US); Lance Warner, Sandusky, OH (US)

(73) Assignee: Advanced Energy Storage, LLC, Sandusky, OH (US)

(21) Appl. No.: 17/914,008

(22) PCT Filed: Mar. 23, 2021
(86) PCT No.: PCT/US2021/023664

§ 371 Date: Sep. 23, 2022

Related U.S. Application Data
(60) Provisional application No. 62/993,170, filed on Mar. 23, 2020.

(51) Int. Cl. F15B 21/14; F03D 9/14; F15B 1/02; F15B 1/033; F15B 1/08; F15B 19/00; F15B 20/00; H02J 15/00; H02J 3/28; F16H 61/4096

(52) U.S. Cl. CPC F15B 21/14; F03D 9/14; F15B 1/08; F15B 1/024; F15B 1/033; F15B 19/005; F15B 20/005; F16H 61/4096; H02J 3/28; H02J 15/003; F05B 2260/422; F15B 2201/50; F15B 2201/205; F15B 2201/411; F15B 2201/413; F15B 2201/4155; F15B 2211/87; F15B 2211/625; F15B 2211/8636; F15B 2211/8757; F15B 2211/30575

(57) ABSTRACT

This invention relates to hydraulic energy storage and management systems. In particular, this invention relates to a hydraulic energy management system that has a reconfigurable energy storage and release capability that adjusts to varying available energy input and power demand output requirements. The hydraulic energy management system can be resized by a hydraulic bridge circuit to permit hydraulic power units to be added or removed, both physically and operationally, to capture available energy over time, adjust to peak demand cycles, and maintain power output in the event of a failure of a portion of the system.

### CROSS-REFERENCE TO RELATED APPLICATIONS

This application claims the benefit of U.S. Provisional Application No. 62/993,170, filed Mar. 23, 2020, the disclosure of which is incorporated herein by reference.

### BACKGROUND OF THE INVENTION

This invention relates, in general, to hydraulic energy storage and management systems. In particular, this invention relates to a hydraulic energy management system that has a reconfigurable energy storage and release capability that adjusts to varying available energy input and power demand output requirements. The hydraulic energy management system can be resized by a hydraulic bridge circuit to permit power units to be added or removed, both physically and operationally, to capture available energy over time, adjust to peak demand cycles, and maintain power output in the event of a failure of a portion of the system.

Hydraulic management and storage systems utilize accumulators to store hydraulic fluid under pressure and release the stored pressure energy as a mechanical output to drive a device. These systems typically capture energy that would be wasted in the form of heat, such as vehicle braking energy, and re-release the energy when a demand is signaled. The accumulator storage systems are sized to capture a predetermined amount of energy and provide a controlled release of the stored energy through valves regulating fluid flow into a hydraulic motor. In stationary power generation applications capturing wind energy for conversion to electrical energy, the load demand and the input power are variable and unassociated with each other. If part of the circuit fails or the accumulator becomes unable to accept additional energy, the system shuts down. In addition, there is no ability to vary the system capacity by rerouting storage and output capability. Thus, it would be desirable to have a hydraulic energy storage and management system that could be resized to accommodate variations in input and output energy volumes or system failures, particularly in remote environments.

### SUMMARY OF THE INVENTION

This invention relates, in general, to hydraulic energy storage and management systems. In particular, this invention relates to a hydraulic energy management system that has a reconfigurable energy storage and release capability that adjusts to varying available energy input and power demand output requirements. The hydraulic energy management system can be resized by a hydraulic bridge circuit to permit hydraulic power units to be added or removed, both physically and operationally, to capture available energy over time, adjust to peak demand cycles, and maintain power output in the event of a failure of a portion of the system.

The hydraulic energy storage and management system can be applied to stationary power applications, particularly remotely located electric generation stations. In one aspect of the invention, the hydraulic energy storage and management system accumulates energy from a wind power source which is stored as pressurized fluid. The system also provides pressurized fluid generated by the external energy source, such as the wind power source, directly to the output load, such as an electric generator. When energy supply is in excess of power demand, the pressurized fluid may be stored in a series of fluid accumulators. These accumulators, and the supporting hydraulic circuitry, are arranged in cells that may be connected together, in series or in parallel, to form energy management pods. In one aspect of the invention, electrical energy is produced from a release of the stored pressurized fluid in each cell as the demand requires. The fluid pressure is released from the accumulators based on the demand and the available incoming power.

FIG. 1 is the basic hydraulic circuit used to store the wind-generated hydraulic pressure and release it, based on a load demand. FIGS. 2A - 2C are the basic cell unit having a plurality of the fluid circuits of FIG. 1 and FIG. 3 is the portable “pod” having a plurality of cells that are “plug-and-play.” As will be described below, in the event of a cell failure or in order to balance the system output with the load demand and input power supply (i.e., windy vs. calm conditions), cells or portions of cells can be brought on-line and balanced with the system demand and available input energy to maintain a desired power output.

Peak load management system: An energy management system that consumes power during times of low energy cost and supplements or replaces power needs. The energy is stored by mechanical means. This embodiment uses a device that has a barrier between a compressible material (gas) and a non-comprisable material (Liquid) to store energy. The system charges by power from the supply source when energy is abundant or at lower cost.

Energy balancing system: Despite mechanical energy storage systems for mechanical energy storage systems being capable of being interconnected with different states of charge if they cannot be isolated from each other, charged and discharged independently or in banks it become difficult if not impossible to tell if a single mechanical unit has failed in the system. This system allows for the isolation of charging and discharging of both modes in banks or single units to locate equipment needing service without bringing whole system out of operation. Energy storage systems of all types have characteristics that change over time and even fail eventually due to time and use or due to defects in their fabrication. When these systems or devices are small in size or reliability of the system is not critical, simple maintenance schedules may be created to reduce the likelihood of failure. These failures range from loss of performance to a component or sub-system ‘weak link’ failure which may cause rapid oxidation (over heating or fire) or a loss of compressible gas or fluid (leak or burst).

This invention provides a mechanical energy storage device configured as an accumulator or as an accumulator and connected gas spring storage means that may be controlled for partition and selective activation or deactivation by way of a hydraulic circuit element. In one embodiment, the accumulator has a compressible fluid (gas) on one side of a barrier and an incompressible fluid (Fluid) on the other side of the barrier. As the fluid is moved in and out of the accumulator, energy is stored through compression of the gas and released during expansion of the gas. The hydraulic circuit element is an actuatable series of valves, some arranged in a Wheatstone Bridge configuration and others provided in conjunction with accumulator fluid or gas volumes, to permit pressurized fluid to be directed to generate power, redirect compressible gas volumes to other accumulator arrangements, and/or isolate accumulators based on a state of charge/discharge or operational capacity.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic of a hydraulic circuit for use in a power cell of a power pod system in accordance with the invention.

FIG. 2A is a perspective view of a hydraulic power cell having 1 or more hydraulic circuits of FIG. 1.

FIG. 2B is an elevational view of an embodiment of an accumulator and separate charge tank, applicable to the hydraulic circuit of FIG. 2A.

FIG. 2C is an elevational view of another embodiment of an accumulator and separate charge tank, applicable to the hydraulic circuit of FIG. 2A.

FIG. 3 is an exploded, perspective view showing a plurality of power cells of FIG. 2 forming a hydraulic power pod in accordance with the invention.

FIG. 4A is a perspective view of an alternate embodiment of the manifold illustrated in FIG. 3, showing the configured as a modular manifold system.

FIG. 4B a perspective view of an alternative embodiment of the manifold illustrated in FIG. 4A configured as a plurality of pipes.

FIG. 5 is an alternate embodiment of the hydraulic circuit illustrated in FIG. 1 showing the Wheatstone Bridge circuit applied to the gas side of the accumulator.

FIG. 6 is a perspective view of the accumulator and separate charge tank illustrated in FIG. 2B shown connected to the hydraulic circuit and having the isolation valve on the gas charge side.

FIG. 7 is a perspective view of a plurality of the accumulators and separate charge tanks illustrated in FIG. 2B shown connected to the hydraulic circuit and having the isolation valve on the gas charge side.

### DETAILED DESCRIPTION OF THE PREFERRED EMBODIMENT

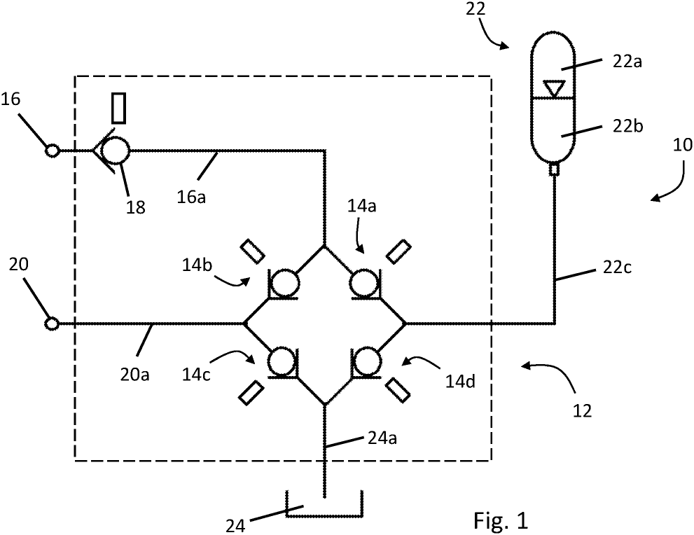

Referring now to the drawings, there is illustrated in FIG. 1 a schematic of a hydraulic circuit, shown generally at 10, that forms a basic control circuit for the hydraulic cells, discussed below. The hydraulic circuit 10 includes a hydraulic-based Wheatstone bridge, shown generally at 12, and comprising solenoid actuated valves 14a, 14b, 14c, and 14d. The valves may be any type of hydraulic flow control valve, such as check valves, spool valves, ball valves, and the like. In the illustrated embodiment, the valves 14a-14d are one-way check valves. Each of the valves 14a-14d may be actuated to permit flow bi-directionally by activating the solenoid portion of the valves.

Energy, in the form of pumped hydraulic fluid, enters the circuit bridge 12 by way of an input port 16 and flows into the bridge 12 through input line 16a. Advantageously, a one-way check valve 18 prevents pressurized fluid from escaping and back-feeding a supply pump (not shown) or pressure or pressure source. The valve 18 may be a solenoid actuated valve. An output port 20 provides regulated fluid flow from the bridge 12 via output line 20a to a load, such as a hydraulic motor (not shown) that supplies mechanical power to an electric generator, for example. The hydraulic circuit 10 further includes at least one accumulator, shown generally at 22, and comprising a pressurized chamber 22a and a fluid storage chamber 22b. The accumulator 22 supplies fluid to the bridge 12 by way of an accumulator output line 22c. The accumulator 22 may be any type of accumulator such as, for example, a bladder-type, diaphragm-type, piston-type, or metal bellows type and may be any suitable number of accumulators. A reservoir 24 is connected to the bridge 12 by tank line 24a to permit accumulator discharge, if necessary or desired.

When valves 14a and 14b are activated to permit fluid flow therethrough, flow of stored energy in the accumulator 22 passes through valves 14a and 14b to the output port 20 allowing the load to be powered by the stored energy. In the event that the pressurized fluid from the input source 16 is intermittent or insufficient to supply stand-alone power, additional energy is supplied by the accumulator 22. The energy management portion of the hydraulic circuit 10 is configured to direct available energy from the input source 16 to drive the load and augment the stored energy supply. Alternatively, if the input source 16 of pressurized fluid is abundant, the input 16 may drive the load demand and add fluid into the accumulator 22. If the accumulator 22 is full and unable to accept additional fluid, the input supply may be deactivated and the accumulator permitted to discharge to a predetermined charge state before reactivating the input source 16. To discharge the accumulator 22, valve 14d is activated to permit fluid flow from the accumulator output line 22c to the tank line 24a and the reservoir 24.

The hydraulic circuit 10 may also include a controllable venting system that allows oxygen in proximity of the hydraulic circuit 10 to be lowered upon the occurrence of a fire or extreme heat condition, thus extending safe operation of the hydraulic circuit 10.

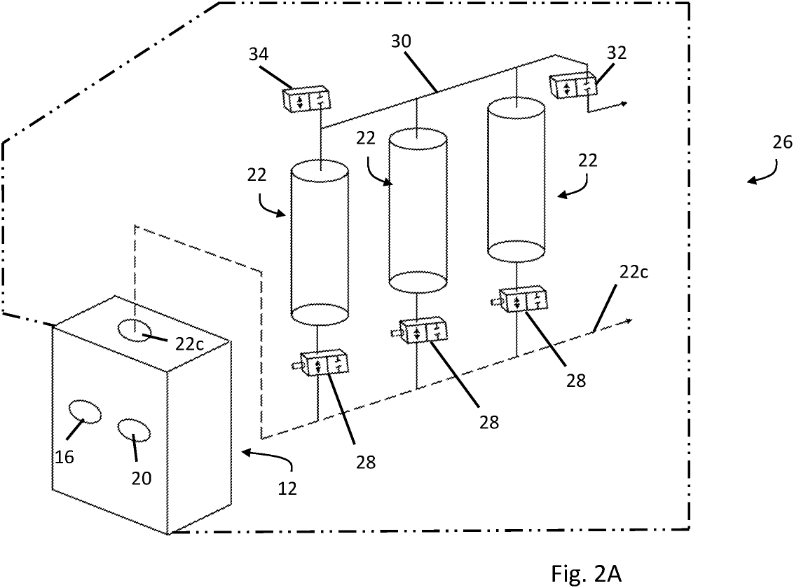

Referring now to FIG. 2A, a schematic illustration of a hydraulic cell is shown generally at 26 and includes one or more of the hydraulic circuits 10 of FIG. 1. In the illustrated embodiment, a plurality of accumulators 22 are connected to the bridge 12 by the accumulator output line 22c. Each of the accumulators 22 is connected to the output line 22c through an output regulator 28. The regulator 28 is configured to control any of fluid flow rate, pressure, and/or flow direction. The regulator 28 may be activated based on the load demand required, individually, as a cascading output from each accumulator, or as a group. The pressurized chamber 22a of each accumulator 22 is charged with a compressible medium, such as an inert gas like nitrogen (N₂), though any suitable gas may be used. The pressurized chambers 22a of each accumulator 22 are connected to a vent line 30 in order to regulate or eliminate the pressure level of the gas. The vent line 30 may be regulated by one or more release valves 32 and 34. Alternatively, each accumulator may have a release valve connected from the pressurized chamber 22a to the vent line 30.

In the event of an accumulator 22 failure or fluid piping failure, a particular accumulator 22 or any combination of accumulators 22 may be disabled by venting the pressurized gas therein. The affected accumulator 22 may be fluidly isolated by its associated regulator 28 and depressurized by the release valve 32 or 34 connected thereto. In the event of a system maintenance activity, the vent line 30 may be used to charge the accumulators from a charging source, such as by a source of pressurized nitrogen or by an air compressor when the inert gas is ambient air. This would permit remote location use and maintenance with minimal support supplies. Advantageously, the hydraulic circuit 10 is configured such that charging sources may be added or removed while the hydraulic circuit 10 remains in operation. Further, the hydraulic circuit 10 is configured such that charging loads may be added or removed while the hydraulic circuit 10 remains in operation.

Referring now to FIG. 2B, a first alternate embodiment of the accumulator 23a is shown as part of an accumulator system 23. The accumulator system 23 also includes a gas pressure vessel or charge tank 23b. The accumulator 23a includes a movable barrier, such as a piston 23d therein that divides the interior of the accumulator 23a into the fluid storage chamber 23e (the upper portion of the accumulator 23a when viewing FIG. 2B) and a pressurized chamber 23f (the lower portion of the accumulator 23a when viewing FIG. 2B). The fluid storage chamber 23e is connected to the accumulator output line 22c. In the illustrated accumulator system 23, the charge tank 23b is fluidly connected to the accumulator 23a via a fluid conduit 23c and also fluidly connected to the vent line 30. The accumulator system 23 may include any desired number of accumulators 23a and desired number of charge tanks 23b, as determined by system requirements.

One end of each accumulator 23a and each charge tank 23b may include safety hardware 23g, such as pressure relief valves, pressure soft plugs, and/or engineered leak/blow-off sections mounted thereto.

Referring now to FIG. 2C, a second alternate embodiment of the accumulator 25a is shown as part of an accumulator system 25. The accumulator system 25 is similar to the accumulator system 23 and includes a gas pressure vessel or charge tank 25b. The accumulator 25a includes a movable barrier, such as a piston 25d therein that divides the interior of the accumulator 25a into the fluid storage chamber 25e (the lower portion of the accumulator 25a when viewing FIG. 2B) and a pressurized chamber 25f (the upper portion of the accumulator 25a when viewing FIG. 2B). The fluid storage chamber 25e is connected to the accumulator output line 22c. In the illustrated accumulator system 25, the charge tank 25b is fluidly connected to the accumulator 25a via a fluid conduit 25c and also fluidly connected to the vent line 30. The accumulator system 25 may include any desired number of accumulators 25a and desired number of charge tanks 25b, as determined by system requirements.

One end of each accumulator 25a and each charge tank 25b may include safety hardware 25g, such as pressure relief valves, pressure soft plugs, and/or engineered leak/blow-off sections mounted thereto.

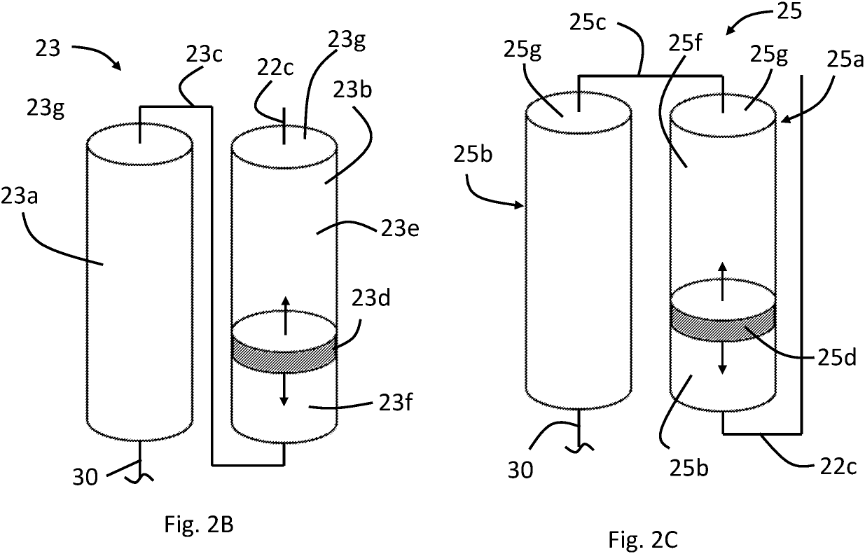

Referring now to FIG. 3, there is illustrated an energy management pod, shown generally at 36. The pod 36 includes the plurality of cells 26 fluidly connected to a pod manifold 38. The manifold 38 includes docking ports, shown generally at 40, that provide fluid coupling of the bridge 12 of each cell 26 to pod output and return lines 42 and 44, respectively that power the intended load, such as an electric generator and/or couple the vent lines to a single pod output/input. The cells 26 and the accumulator 22 or the accumulator systems 23 and 25 may be palletized. Thus, the cells 26 are configured such that the accumulator 22 or the accumulator systems 23 or 25 may be mounted on, and supported by, a surface 27 of the cell 26 (the upwardly facing surface when viewing FIG. 3). The cells 26 provide a foundation that reinforces the a base of the accumulators 22 and the accumulator systems 23 and 25 when, in the event of a direct pressure release or explosion, energy is directed upwardly toward the safety hardware 23g and 25g.

The manifold 38 may include fluid regulating valves or check valves to permit connected cells to operate when one or more are disabled. The cells 26 may be fluidly isolated from the manifold 38 and removed or added in a plug-and-play arrangement. This ability to remove or add cells 26 provides for a system that may be reconfigured or resized based on the demand required, the operational status of the system, and/or the external energy source availability. In addition, several energy management pods 36 may also be linked together to form an even larger energy management system.

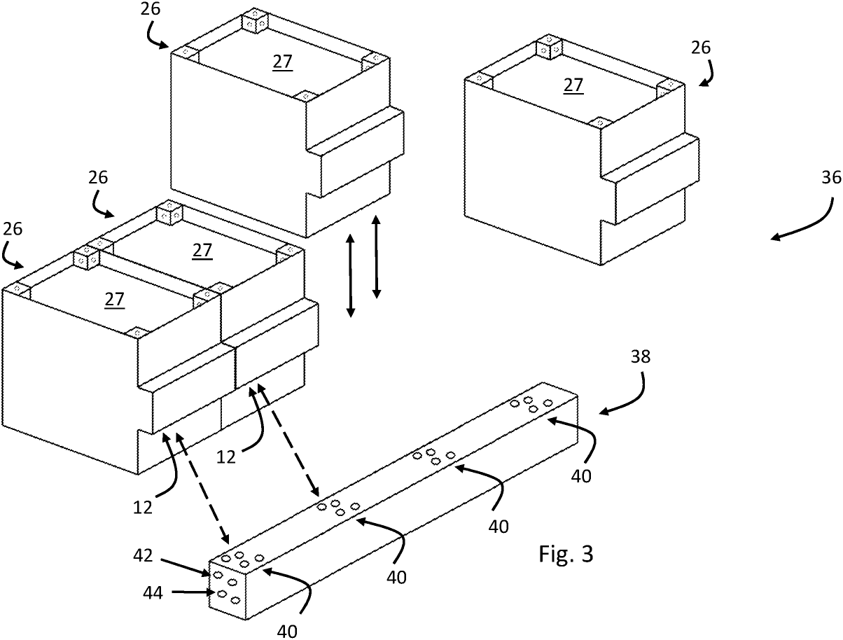

Additionally, the manifold 38 may be configured as a modular manifold, as shown as 138 in FIG. 4A. The modular manifold 138 includes a plurality of manifold segments 139, each of which includes docking ports 140. The docking ports 140 provide fluid coupling of the bridge 12 of each cell 26 the energy management pod 36 output and return lines 142 and 144, respectively, that power the intended load. Thus, the modular manifold 138 may be scaled by adding or removing manifold segments 139 allowing for the addition or removal of palletized cells 26.

Referring now to FIG. 4B, the energy management pod 36 may be configured as a pipe system 150 rather than a manifold. The pipe system 150 includes a plurality of pipe segments 152, each having a plurality of pipes 154. In the illustrated embodiment, each pipe segment 152 includes four pipes 154, each pipe 154 having an opening defining a docking port 156. One pair of pipes 154 define the output lines 158 and one pair of pipes 154 define the return lines 160.

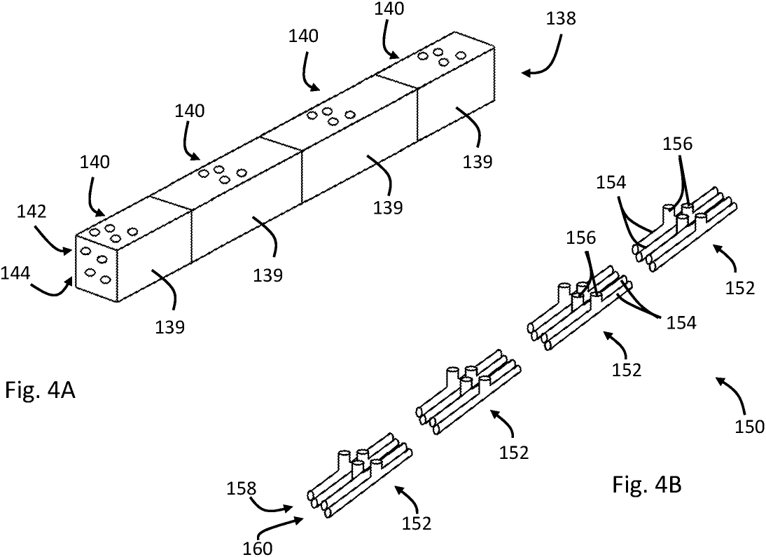

FIG. 5 illustrates an alternate embodiment of the hydraulic circuit, shown generally at 100. The circuit 100 forms a basic control circuit for the hydraulic cells, discussed below. The hydraulic circuit 100 includes the hydraulic-based Wheatstone bridge, shown generally at 112. The hydraulic-based Wheatstone bridge 112 is similar to the bridge 12 and includes solenoid actuated valves 114a, 114b, 114c, and 114d. The valves may be any type of hydraulic flow control valve, such as check valves, spool valves, ball valves, and the like. In the illustrated embodiment, the valves 114a-114d are one-way check valves. Each of the valves 114a-114d may be actuated to permit flow bi-directionally by activating the solenoid portion of the valves.

Energy, in the form of pumped hydraulic fluid, enters the circuit bridge 112 by way of an input port 116 and flows into the bridge 112 through input line 116a. Advantageously, a one-way check valve 118 prevents pressurized fluid from escaping and back-feeding a supply pump (not shown) or pressure or pressure source. The valve 118 may be a solenoid actuated valve. An output port 120 provides regulated fluid flow from the bridge 112 via output line 120a to a load, such as a hydraulic motor (not shown) that supplies mechanical power to an electric generator, for example. The hydraulic circuit 100 further includes at least one accumulator, shown generally at 122, and comprising a pressurized chamber 122a and a fluid storage chamber 122b. The accumulator 122 supplies fluid to the bridge 112 by way of an accumulator output line 122c. A reservoir 124 is connected to the bridge 112 by tank line 124a to permit accumulator discharge, if necessary or desired.

When valves 114a and 114b are activated to permit fluid flow therethrough, flow of stored energy in the accumulator 122 passes through valves 114a and 114b to the output port 120 allowing the load to be powered by the stored energy. In the event that the pressurized fluid from the input source 116 is intermittent or insufficient to supply stand-alone power, additional energy is supplied by the accumulator 122. The energy management portion of the hydraulic circuit 100 is configured to direct available energy from the input source 116 to drive the load and augment the stored energy supply. Alternatively, if the input source 116 of pressurized fluid is abundant, the input 116 may drive the load demand and add fluid into the accumulator 122. If the accumulator 122 is full and unable to accept additional fluid, the input supply may be deactivated and the accumulator permitted to discharge to a predetermined charge state before reactivating the input source 116. To discharge the accumulator 122, valve 114d is activated to permit fluid flow from the accumulator output line 122c to the tank line 124a and the reservoir 124.

Additionally, the hydraulic circuit 100 includes a second Wheatstone bridge 112 fluidly connected to the pressurized chamber 122a of the accumulator 122. In this configuration, the input ports 116 and the output ports 120 may be used to transfer pressurized gas between one accumulator 122 and one or more additional accumulators 122 to modify the pressure or storage capability of the connected accumulators 122.

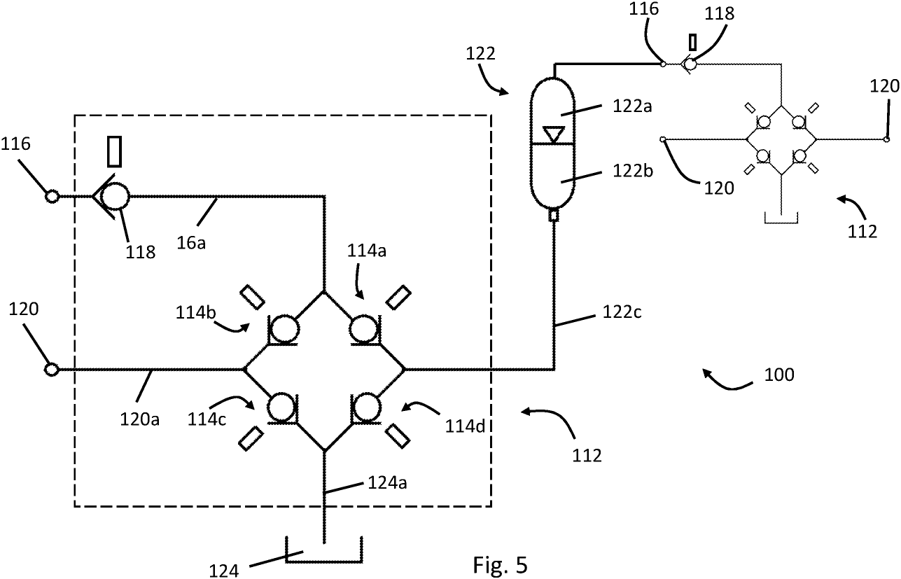

Referring now to FIG. 6, a portion of the hydraulic cell 26, such as shown in FIG. 2A is shown and includes the bridge 12 having the input port 16, the output port 20, and the accumulator output line 22c. The hydraulic cell 26, and its associated bridge 12, may be one of a plurality of hydraulic cells 26. The illustrated embodiment also includes the accumulator system 25. The accumulator system 25 includes the accumulator 25a and the charge tank 25b connected by the fluid conduit 25c. The accumulator 25a is connected to the output line 22c via the output regulator 28. As descried above, the output regulator 28 is configured to control any of fluid flow rate, pressure, and/or flow direction.

As described above, the charge tank 25b is connected to the vent line 30 in order to regulate or eliminate the pressure level of the gas. The vent line 30 may be regulated by one or more release valves 34. Additionally, release valve 32 may be positioned between the charge tank 25b and the vent line 30.

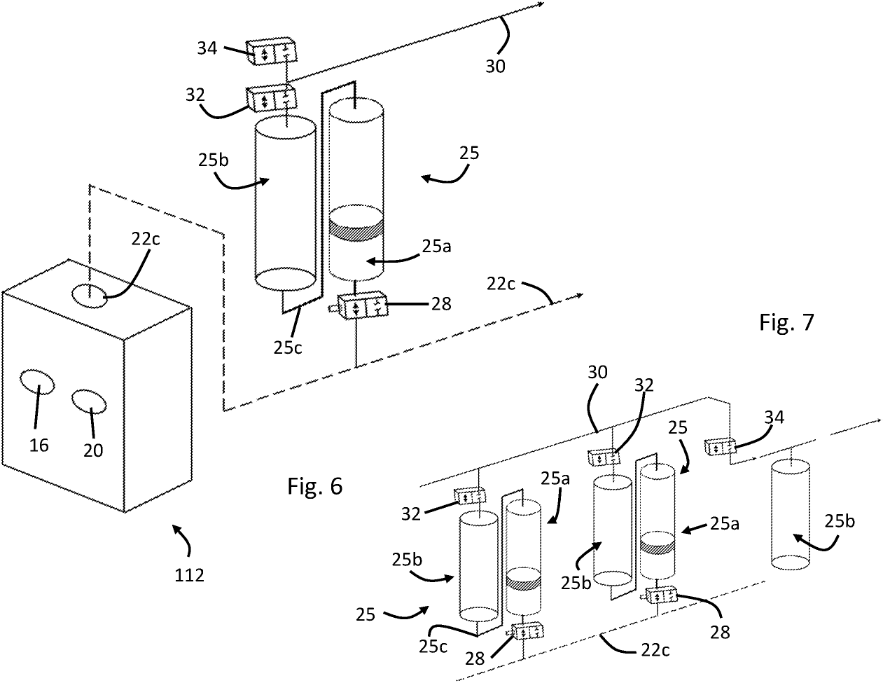

Referring now to FIG. 7, a series two accumulator systems 25 are shown with an additional charge tank 25b. As shown in FIG. 6, the accumulators 25a are connected to the output line 22c via output regulators 28, and release valves 32 are positioned between the charge tanks 25b and the vent line 30. The vent line 30 is regulated by a release valves 34, which further regulates the flow of pressurized gas to the additional charge tank 25b. It will be understood that any number of accumulator systems 25 and any number of additional charge tanks 25b may be provided.

Referring again to FIGS. 5 through 7, the hydraulic circuit 100 having the illustrated embodiments of the accumulator system 25, regulators 28, and release valves 32 and 34 have advantages over conventional hydraulic circuits. For example, it the event that available charge gas for the hydraulic circuit 100 is less than a required system operating pressure, gas may be fed into the circuit bridge 112 to directly fill the charge tank 25b and the gas side of the accumulators 25a. The hydraulic circuit 100 as shown in FIG. 5 will then start charging the fluid side of the accumulators 25a closest to the gas source, thus causing the pressure in all the accumulator systems 25 to increase.

This process may continue until the yet dry accumulators 25a reach a desired operational pressure with a slight over-charge. The full pressure dry accumulators 25a may then be closed off from the gas charging system and the fluid in all the wet accumulators 25a may be drained to the reservoir 124 or via the valve 118. The accumulators 25a having lower pressure may continue to be filled with the lower pressure from the circuit bridge 112 and the cycle may continue until only one accumulator system 25 as a pressure below full charge. The surplus charge in all the other accumulators 25a in the hydraulic circuit 100 may be drained into the undercharged accumulator systems 25, thus creating a fully pre-charged hydraulic circuit 100 ready for operation.

Further, in the event that one or more accumulators 25a is damaged or otherwise fails, all of the accumulators 25a except the damaged accumulator 25a will closed from the circuit bridge 112 via the regulator 28. The damaged accumulator 25b may then drain safely either through the valve 118 and the input port 116, or to reservoir, as determined to be the safest approach by a hydraulic circuit 100 controller.

Significantly, if a fluid leak is detected into the gas, the fluid will be drained to the reservoir 124. If a failure is detected in the charge tank 25b or the gas side of the accumulators 25a, the gas will be vented to the atmosphere via the release valves 32.

Advantageously, the various embodiments of the hydraulic circuits 10 and 100 described above are configured to allow the user to test the charge and discharge characteristics of the accumulator 22 or the accumulator systems 23 and 25 without taking the overall system off-line at any time. Each of the cells 26 may be isolated or quarantined from additional cells 26 in the hydraulic circuits 10 and 100 to allow safe operation to the rest of the hydraulic circuits 10 and 100 even if failure of the quarantined cell is catastrophic.

Each cell 26 may be configured to allow the cell 26 to neutralize itself automatically should it be determined unsafe to remain operational. Each cell 26 may also be configured to be neutralized manually should a qualified person in proximity of the hydraulic circuits 10 and 100 determine that the hydraulic circuits 10 and 100, or portions thereof, are unsafe or in an environment that is unsafe for continued operation. The hydraulic circuits 10 and 100 may further be configured such that a cell 26 may be neutralized remotely should an authorized person with access to the hydraulic circuits 10 and 100 determine that the hydraulic circuits 10 and 100, or portions thereof, are unsafe or in an environment that is unsafe for continued operation.

The hydraulic circuits 10 and 100 may be configured such that cells 26 may be added or removed therefrom during operation of the hydraulic circuits 10 and 100.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A hydraulic circuit comprising:
a fluid circuit bridge having an input port connected to an input line, and an output port; and
an accumulator fluidly connected to the fluid circuit bridge by an accumulator output line;
wherein the fluid circuit bridge includes a one-way valve in the input line.

2. The hydraulic circuit according to claim 1, wherein the fluid circuit bridge is a hydraulic-based Wheatstone bridge.

3. The hydraulic circuit according to claim 1, wherein the one-way check valve is configured to prevent pressurized fluid from escaping outwardly through the input port toward a pressure source.

4. The hydraulic circuit according to claim 1, wherein the accumulator includes a pressurized gas chamber and a fluid storage chamber separated by a movable barrier.

5. The hydraulic circuit according to claim 4, wherein the accumulator is a plurality of accumulators.

6. The hydraulic circuit according to claim 5, further including a housing in which the fluid circuit bridge is mounted, the housing defining a cell.

7. The hydraulic circuit according to claim 5, wherein the cell includes a surface upon which the accumulators are mounted.

8. The hydraulic circuit according to claim 7, further including safety hardware mounted to each of the accumulators at a longitudinal end opposite the cell surface.

9. The hydraulic circuit according to claim 5, wherein each accumulator includes a release valve between the pressurized gas chamber and a vent line fluidly connecting the pressurized gas chambers of each of the accumulators; and
wherein the hydraulic circuit is configured to vent gas to the atmosphere from any one or more of the pressurized gas chambers of the accumulators.

10. The hydraulic circuit according to claim 1, wherein the accumulator is an accumulator system including an accumulator having a pressurized gas chamber and a fluid storage chamber separated by a movable barrier, and a charge tank fluidly connected to the pressurized gas chamber of the accumulator.

11. A hydraulic circuit system comprising:
a plurality of hydraulic circuits, each circuit having:
a fluid circuit bridge having an input port connected to an input line, an output port, and a fluid reservoir connected to a tank line;
wherein the fluid circuit bridge includes a one-way valve in the input line; and
a plurality of accumulators fluidly connected to the fluid circuit bridge by an accumulator output line;
wherein each accumulator includes a pressurized gas chamber and a fluid storage chamber separated by a movable barrier;
wherein each accumulator includes a release valve between the pressurized gas chamber and a vent line fluidly connecting the pressurized gas chambers of each of the accumulators; and
wherein the hydraulic circuit is configured to vent gas to the atmosphere from any one or more of the pressurized gas chambers of the accumulators.

12. The hydraulic circuit system according to claim 11, wherein when available pressurized gas for the hydraulic circuit is less than a required hydraulic circuit system operating pressure, gas is fed into the circuit bridge to directly fill the pressurized gas chambers of the accumulators; and
subsequently, the hydraulic circuit will start charging the fluid storage chambers of the accumulators beginning with the accumulators closest to a source of the pressurized gas, thus causing fluid pressure in each accumulator to increase, and continue until each accumulator reaches a predetermined operational pressure.

13. A hydraulic circuit system comprising:
a plurality of hydraulic circuits, each circuit having:
a fluid circuit bridge having an input port connected to an input line, and an output port; and
an accumulator fluidly connected to the fluid circuit bridge by an accumulator output line;
wherein the fluid circuit bridge includes a one-way valve in the input line.

14. The hydraulic circuit system according to claim 13, wherein the fluid circuit bridge is a hydraulic-based Wheatstone bridge.

15. The hydraulic circuit according to claim 13, wherein the one-way check valve is configured to prevent pressurized fluid from escaping outwardly through the input port toward a pressure source.

16. The hydraulic circuit according to claim 13, wherein the accumulator includes a pressurized gas chamber and a fluid storage chamber separated by a movable barrier.

17. The hydraulic circuit according to claim 16, wherein the accumulator is a plurality of accumulators, the hydraulic circuit further including a housing in which the fluid circuit bridge is mounted, the housing defining a cell; and wherein the cell includes a surface upon which the accumulators are mounted.

18. The hydraulic circuit according to claim 17, further including safety hardware mounted to each of the accumulators at a longitudinal end opposite the cell surface.

19. The hydraulic circuit according to claim 17, wherein each accumulator includes a release valve between the pressurized gas chamber and a vent line fluidly connecting the pressurized gas chambers of each of the accumulators; and
wherein the hydraulic circuit is configured to vent gas to the atmosphere from any one or more of the pressurized gas chambers of the accumulators.

20. The hydraulic circuit according to claim 13, wherein the accumulator is an accumulator system including an accumulator having a pressurized gas chamber and a fluid storage chamber separated by a movable barrier, and a charge tank fluidly connected to the pressurized gas chamber of the accumulator.
